(19) United States
(12) Patent Application Publication
(10) Pub. No.: US 2018/0141608 A1
(43) Pub. Date: May 24, 2018

(54) RETROFIT ELECTRIC DRIVE APPARATUS

(71) Applicant: Next Wave Motors LLC, Binghamton, NY (US)

(72) Inventors: Erik Leonard, Binghamton, NY (US); Stephen Musok, Binghamton, NY (US)

(21) Appl. No.: 15/715,617

(22) Filed: Sep. 26, 2017

Related U.S. Application Data
(60) Provisional application No. 62/399,844, filed on Sep. 26, 2016.

(51) Int. Cl. B62K 11/04; B60K 1/04; B60L 11/18; B62M 9/00

(52) U.S. Cl. CPC B62K 11/04; B60K 1/04; B60L 11/1877; B60K 2001/0461; B62K 2204/00; B60K 2001/0405; B62M 9/00

(57) ABSTRACT

A retrofit electric drive apparatus is provided for converting a fossil fuel fitted motorcycle into an electric-powered motorcycle. In an embodiment, the apparatus includes a housing supporting electric drive train components. At least a portion of the housing is shaped to congruously match a portion of the motorcycle frame and reside within an envelope defined by the motorcycle frame.

In another embodiment, the retrofit electric drive apparatus comprises a housing including a first side element and a second side element, the first side element connected to the second side element at a predetermined spacing to create an internal space. The housing is shaped to reside within an envelope defined by the motorcycle frame and has at least a portion congruous with a portion of the motorcycle frame defining the envelope.

In another embodiment, the retrofit electric drive apparatus comprises a housing kit.

### REFERENCE TO RELATED APPLICATIONS

This application claims one or more inventions which were disclosed in Provisional Application No. 62/399,844, filed Sep. 26, 2016, entitled “Retrofit Electric Drive Apparatus”. The benefit under 35 USC § 119(e) of this United States provisional application is hereby claimed, and the aforementioned provisional application is hereby incorporated herein by reference.

### BACKGROUND OF THE INVENTION

The present application relates to a drive train system for motorcycles, and more particularly to an electric drive apparatus for motorcycles.

The first motorbike was built in 1868 and powered by a steam engine. Subsequent evolutions of the motorcycle have included gasoline-based engines and battery-powered (electric) driven engines.

There are currently a variety of combustion engine fossil-fuel motorcycles available for purchase in various configurations. There are far fewer options available when purchasing an electric motorcycle, and even fewer, or no, options available to purchase a system for converting a gas-powered motorcycle to an electric-powered motorcycle. There is no large scale commercially produced conversion system available for motorcycles at this time.

### SUMMARY OF THE INVENTION

According to various embodiments, a retrofit electric drive apparatus is provided for converting a fossil fuel fitted motorcycle into an electric-powered motorcycle. In an embodiment, the apparatus includes a housing including a motorcycle frame mounting element for fastening to a motorcycle frame, a battery pack mounted to the housing, a battery charger electrically coupled to the battery pack to electrically charge the battery pack from an AC power source, and an electric motor operatively coupled to the battery pack by an electric motor controller and controlled by a battery management system. The housing is shaped to reside within an envelope defined by the motorcycle frame, and at least a portion of the housing is shaped to congruously match a portion of the motorcycle frame. The electric motor is mounted to the housing and coupled to a drive shaft, and the drive shaft is configured to connect to a sprocket and chain drive mechanism of the motorcycle.

In another embodiment, the retrofit electric drive apparatus includes a housing kit including a first plate element, a second plate element, at least one spacer configurable to space the first plate from the second plate, and a motorcycle frame mounting element for fastening the first plate and the second plate to a motorcycle frame. The first plate element is fastenable to the second plate element at a spacing determined by the at least one spacer. The first plate element and the second plate element are each shaped to reside within an envelope defined by the motorcycle frame.

In another embodiment, the retrofit electric drive apparatus includes a housing including a first side element and a second side element, the first side element connected to the second side element at a predetermined spacing to create an internal space between the first side element and the second side element. The housing is shaped to reside within an envelope defined by the motorcycle frame, and at least a portion of the housing is shaped to be congruous with the motorcycle frame defining the envelope, the envelope being under a seat of the motorcycle and between a front wheel and a rear wheel of the motorcycle.

### BRIEF DESCRIPTION OF THE DRAWING

These and other features of this invention will be more readily understood from the following detailed description of the various aspects of the invention taken in conjunction with the accompanying drawings that depict various embodiments of the disclosure, in which:

FIG. 1 illustrates an isometric view of a retrofit electric drive apparatus configured to mount to a frame of a fossil fuel drive train fitted motorcycle in replacement of the fossil fuel drive train, according to an embodiment;

FIG. 2 illustrates a side view of a first plate of a housing of the retrofit electric drive apparatus of FIG. 1.

FIG. 3 illustrates a side view of a second plate of the housing of the retrofit electric drive apparatus of FIG. 1.

FIG. 4 illustrates a top-down isometric view of the retrofit electric drive apparatus of FIG. 1 mounted to a partially shown frame of a 2005 Kawasaki Ninja 250 (sans the fossil fuel based drive train).

FIG. 5 illustrates a bottom-up isometric drawing view of the retrofit electric drive apparatus of FIG. 1 mounted to a partially shown frame of a 2005 Kawasaki Ninja 250 (sans the fossil-fuel based drive train), according to an embodiment.

FIG. 6 illustrates a front view of a mounting plate for battery pack, according to an embodiment.

FIG. 7 illustrates an isometric view of the retrofit electric drive apparatus of FIG. 1 mounted to a partially shown frame of a 2005 Kawasaki Ninja 250 (sans the fossil-fuel based drive train).

FIG. 8 illustrates an isometric view of the retrofit electric drive apparatus of FIG. 1 mounted to a partially shown frame of a 2005 Kawasaki Ninja 250 (sans the fossil-fuel based drive train).

FIG. 9 illustrates an isometric view of the retrofit electric drive apparatus of FIG. 1 mounted to a partially shown frame of a 2005 Kawasaki Ninja 250 (sans the fossil-fuel based drive train).

FIG. 10 illustrates an isometric drawing view of the retrofit electric drive apparatus of FIG. 1 mounted to a partially shown frame of a 2005 Kawasaki Ninja 250 (sans the fossil-fuel based drive train).

FIG. 11 is a block diagram of the operational relationship of drive train components of the retrofit electric drive apparatus, according to one embodiment.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

When an element or layer is referred to as being “on”, “engaged to”, “connected to”, “coupled to”, or “mounted to” another element, it may be directly on, engaged, connected, coupled, or mounted to the other element, or intervening elements or layers may be present. In contrast, when an element is referred to as being “directly on,” “directly engaged to”, “directly connected to”, “directly coupled to”, or “directly mounted to” another element, there may be no intervening elements present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

Disclosed herein is a retrofit electric drive apparatus for converting a fossil fuel drive train fitted motorcycle to an electric drive train fitted motorcycle. The retrofit electric drive apparatus includes a housing that mounts to the frame of the fossil fuel drive train fitted motorcycle, and houses fossil fuel replacement components necessary to create an electric drive train.

The retrofit electric drive apparatus provides current motorcycles owners with the option to convert their motorcycles to complete electric vehicles, an option which has several advantages over fully engineered electric motorcycles. Utilizing this option, a motorcycle owner can retain his current motorcycle in lieu of purchasing another. The cost of an electric vehicle can be prohibitive and a retrofit conversion system can provide less restrictive access to an electric vehicle. Further, retrofitting an existing combustion engine powered motorcycle allows for the removal of a greenhouse gas-emitting vehicle from the public roadways.

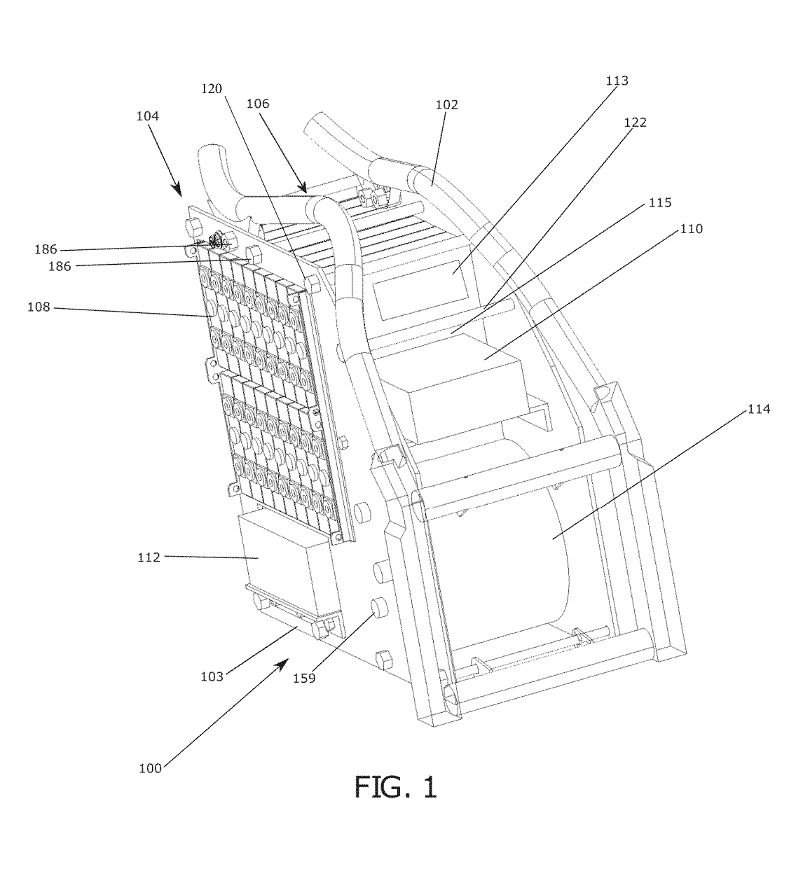

FIG. 1 illustrates an isometric view of a retrofit electric drive apparatus 100 mounted to a frame 102 of a fossil fuel drive train fitted motorcycle, according to an embodiment. Only a portion of frame 102 is shown. Retrofit electric drive apparatus 100 is mounted below frame 102, beneath a rider (not shown), and between the front and rear wheels (not shown). Retrofit electric drive apparatus 100 can be sized and shaped to fit within an envelope 103 of frame 102 no wider than frame 102 (width being from a rider's left to right in an upright orientation of the motorcycle). Fitting the retrofit electric drive apparatus 100 within envelope 103 of frame 102 maintains the exterior profile of the motorcycle, minimizes or avoids obstruction with the rider's legs, minimizes or avoids negative effects on motorcycle aerodynamics, and minimizes alteration of the overall cosmetic appeal of the motorcycle. Regarding this latter benefit, the housing can be designed and decorated to blend with and/or enhance the look and style of the motorcycle.

In FIG. 1, the fossil fuel drive train fitted motorcycle is a 2005 Kawasaki Ninja 250 (sans the fossil fuel drive train), and retrofit electric drive apparatus 100 is configured to mount to the 2005 Kawasaki Ninja 250, though retrofit electric drive apparatus 100 can be mounted to, and/or can drive, other models of fossil fuel drive train fitted motorcycles, either in the exact configuration illustrated and described with reference to FIG. 1, or with appropriate structural modifications to mount to differently sized or shaped frames, and appropriate electrical modifications to obtain desired drive specifications (e.g., torque, horsepower, cc's).

As seen in FIG. 1, retrofit electric drive apparatus 100 can include a housing 104 and electric drive train components 106 supported by housing 104. Electric drive train components can include a battery pack 108, a motor controller 110, a battery charger 112, a battery management system 113, an electric motor 114, and a voltage regulator 115 (shown with dotted lines as it is obscured by other structures in FIG. 1), which can each be an off-the-shelf product, or a custom-fabricated product. In some embodiments, housing 104 can be supplied with no electric drive train components 106, or with removable electric drive train components 106, and a user can supply desired electric drive train components. In this manner, retrofit electric drive apparatus 100 enables a user to tinker with different electric drive train components as might suit the user's preference. Though not limited to the following off-the-shelf electric drive train components 106, in FIG. 1, battery pack 108 includes 16 CALB branded (CAM72FIECPC-calb-pbb2) battery cells rated 72AH, 3.2V wired together to form a single battery back; motor controller 110 is an Alltrax motor controller; battery management system 113 is an Orion Jr. BMS; and electric motor 114 is a 12-24V Mars/Etek brushed motor, part number ME0810.

Battery pack 108, motor controller 110, battery charger 112, and electric motor 114 are supported by housing 104, which can include a first plate 116 and a second plate 118. First plate 116 and second plate 118 can be fastened into a stationary position relative to each other, with first plate 116 substantially parallel to second plate 118 (e.g., parallel within plus or minus 10 degrees). Fasteners such as bolts 120 can tighten first plate 116 toward second plate 118, and one or more electric drive train components 106 can act as spacers to space first plate 116 from second plate 118, or spacers 122 can space first plate 116 from second plate 118. Notably, while flat plates 116, 118 are shown, the plates 116, 118 can alternatively be convex, concave, integrally connected as one piece, and/or otherwise shaped to fit a particular motorcycle, aerodynamic, or desired aesthetic. It should also be noted that while bolts 120 are described, any suitable method, now-known or future-developed, to fasten first plate 116 to second plate 118, can be utilized.

Battery pack 108, motor controller 110, battery charger 112, and electric motor 114 can be secured to one or both of first plate 116 or second plate 118, removably secured to one or both of first plate 116 or second plate 118, and/or secured between first plate 116 and second plate 118. It should be noted that while battery pack 108, motor controller 110, battery charger 112, and electric motor 114 are illustrated in a particular configuration relative to each other electric drive train component 106, these electric drive train components 106 can be configured otherwise (e.g., to fit within variously sized or shaped housings 104 configured for variously sized or shaped motorcycle frames).

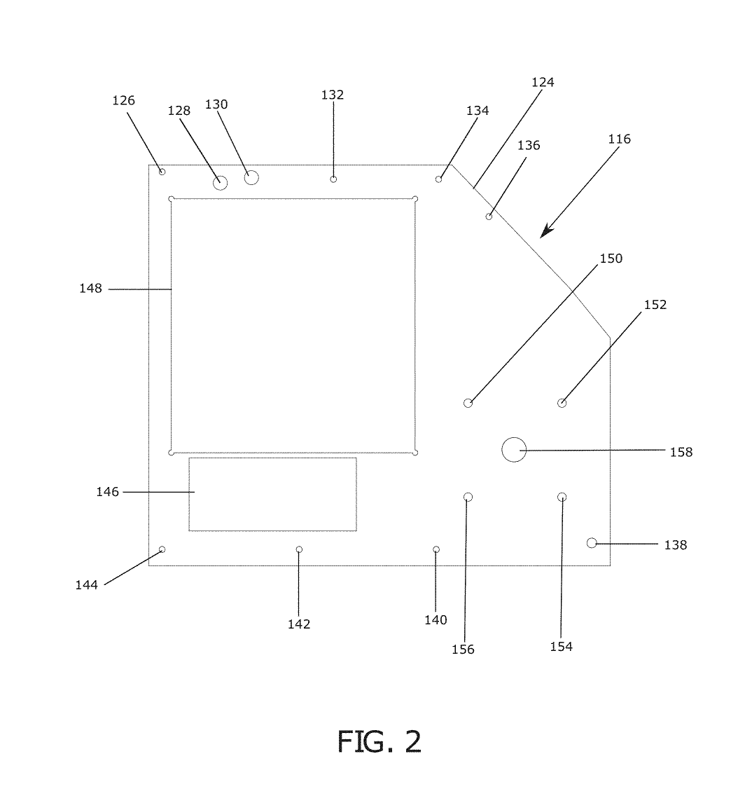

FIG. 2 illustrates a side view of first plate 116 of retrofit electric drive apparatus 100. First plate 116 can be shaped to fit and fasten onto OEM frame 102 (see FIG. 1) of the 2005 Kawasaki Ninja 250 without modification to original frame 102. A portion of a perimeter of first plate 116 congruously matches a portion of the shape of frame 102 that defines envelope 103 (FIG. 1). In FIG. 2, the shape is that of a square with a chamfered corner 124. The congruity need not be exact or 100%. Rough or approximate congruity qualifies as a “congruous match”. In some embodiments, a congruous match exists where at least two adjacent frame 102 portions angled differently with respect to each other intersect, couple with, attach to, mate with, fasten to, or contact differently angled, adjacent perimeter portions of first plate 116.

Also represented in FIG. 2 are various fastener openings, such as bolt holes 126, 128, 130, 132, 134, 136, 138, 140, 142, and 144. These bolt holes 126, 128, 130, 132, 134, 136, 138, 140, 142, and 144 accept a bolt 120 (see FIG. 1).

First plate 116 can also include electric drive train component openings, such as: a battery charger opening 146 into which battery charger 112 can be inserted, accessed, or removed; and a battery pack opening 148 into which battery pack 108 can be inserted, accessed, or removed. These openings 146, 148 facilitate relatively easy maintenance and/or modification. Each of battery charger opening 146 and battery pack opening 148 are shown as being rectangular in FIG. 2, to match the cross-sectional shape of battery charger 112 and battery pack 108, respectively. These shapes can vary along with the cross-sectional shapes of battery charger 112 and battery pack 108.

First plate 116 can also include electric motor mounting fastener holes, such as electric motor mounting bolt holes 150, 152, 154, and 156. A bolt can be placed through electric motor mounting bolt holes 150, 152, 154, and 156 to mount electric motor 114 to first plate 116.

First plate 116 can also include a drive shaft opening 158 through which a drive shaft 159 (see FIG. 1) of electric motor 114 can extend. Drive shaft opening 158 can be centered between electric motor mounting bolt holes 150, 152, 154, and 156, such that bolts are symmetrically spaced around the drive shaft to help provide balanced rotation and support.

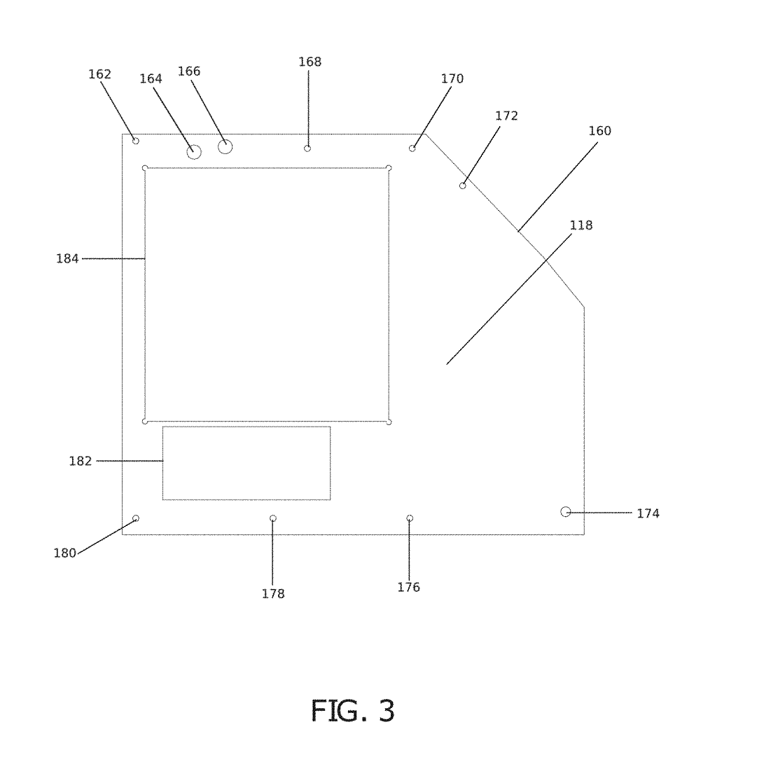

FIG. 3 illustrates a side view of second plate 118. Second plate 118 mirrors first plate 116 to a significant extent. Like first plate 116, second plate 118 can be shaped to fit and fasten onto OEM frame 102 of the 2005 Kawasaki Ninja 250 without modification to original frame 102. A portion of a perimeter of second plate 118 congruously matches the shape of a portion of frame 102. In FIG. 3, the shape is that of a square with a chamfered corner 160. The congruity need not be exact or 100%. Rough or approximate congruity qualifies as a “congruous match”. In some embodiments, a congruous match exists where at least two adjacent frame 102 portions angled differently with respect to each other intersect, couple with, attach to, mate with, fasten to, or contact differently angled, adjacent perimeter portions of second plate 118.

Also represented in FIG. 3 are various fastener openings, such as bolt holes 162, 164, 166, 168, 170, 172, 174, 176, 178, and 180. These bolt holes 162, 164, 166, 168, 170, 172, 174, 176, 178, and 180, accept the bolt 120 (see FIG. 1). Second plate 118 can also include electric drive train component openings 106, such as: a battery charger opening 182 into which battery charger 112 can be inserted, accessed, or removed; and a battery pack opening 184 into which battery pack 108 can be inserted, accessed, or removed. These openings 182, 184 facilitate relatively easy maintenance and/or modification. Each of battery charger opening 182 and battery pack opening 184 are shown as being rectangular in FIG. 3, to match the cross-sectional shape of battery charger 112 and battery pack 108, respectively. These shapes can vary along with the cross-sectional shapes of battery charger 112 and battery pack 108.

Referring to FIGS. 1-3, each threaded bolt 120 can be placed through one of bolt holes 126, 132, 134, 136, 138, 140, 142, and 144, then through a respective one of cylinder spacers 122 (see FIG. 1), then through a respective one of bolt holes 162, 168, 170, 172, 174, 176, 178, and 180 on second plate 118 as illustrated in FIG. 3. Bolts 120 can be terminated with a nut (not shown). Alternatively, bolts 120 can thread into one or the other of first plate 116 and second plate 118. Referring to FIGS. 1-3, a threaded bolt 186 can be placed through each of bolt holes 128, 130, and then through a respective one of each of bolt holes 164, 166, joining the motorcycle to the OEM bolt hole of the original frame 102 of the motorcycle. Bolts 186 are each terminated with a nut (not shown).

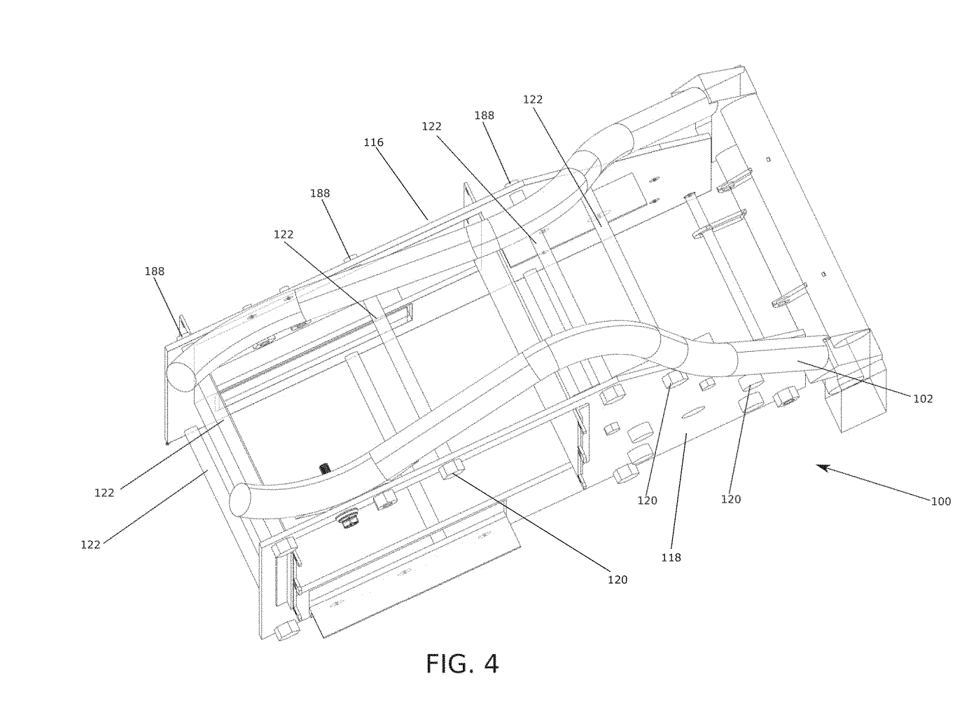

FIG. 4 illustrates a top-down isometric view of retrofit electric drive apparatus 100 mounted to the partial frame 102 of a 2005 Kawasaki Ninja 250 (sans the fossil fuel based drive train). In FIG. 4, four cylinder spacers 122 are shown through which bolts are placed in order to assemble together the first and second plates 116, 118, which form the left and right sides of the conversion apparatus. These spacers 122 separate first and second plates 116, 118 at a distance such that plates 116, 118 are able to mount onto OEM frame 102 of the motorcycle and house all electric drive train components 106 (see FIG. 1).

In FIG. 4, threaded bolts 120, spacers 122, and nuts 188 are shown fastening first plate 116 a specified distance from second plate 118. Each threaded bolt 120 is placed into a respective bolt hole in first or second plate 116, 118, passed through a spacer 122, passed through a respective bolt hole in the other of first or second plate 116, 118, and terminated with a nut 188.

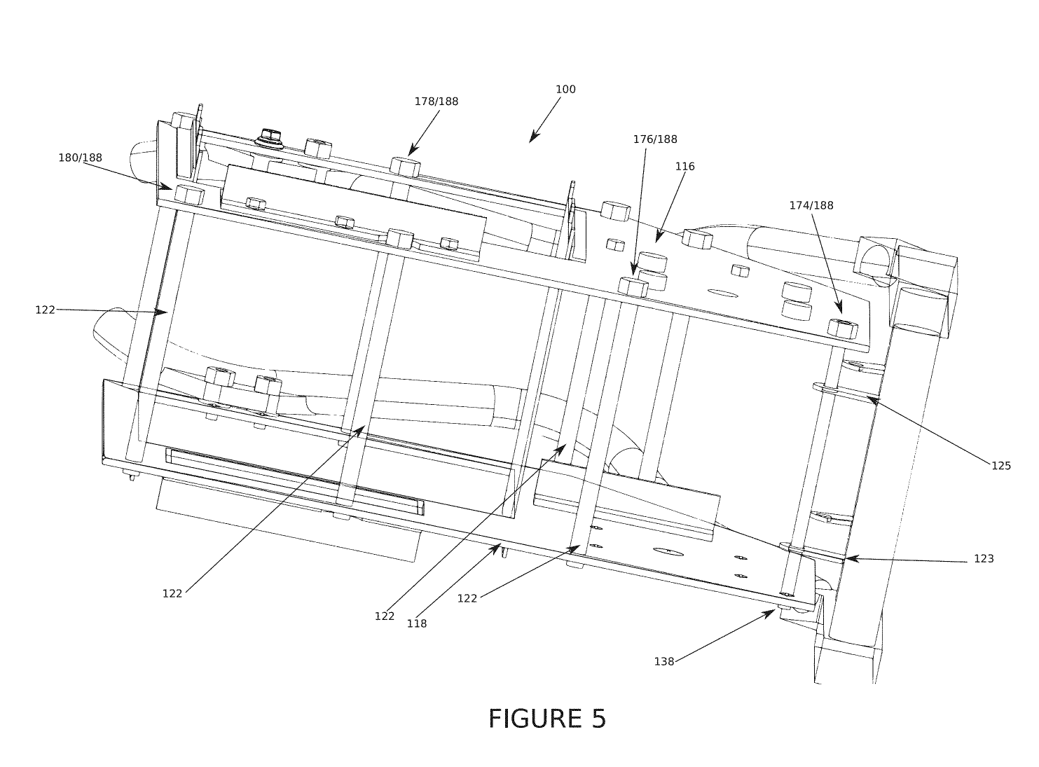

FIG. 5 illustrates a bottom-up isometric drawing view of retrofit electric drive apparatus 100 mounted to the partially shown frame 102 of a 2005 Kawasaki Ninja 250 (sans the fossil-fuel based drive train). In FIG. 5, four cylinder spacers 122 are shown through which bolts are placed in order to assemble together first and second plates 116, 118, which form the left and right sides of the conversion apparatus. These spacers 122 separate first and second plates 116, 118 at a distance such that plates 116, 118 are able to mount onto OEM frame 102 of the motorcycle and house all electric drive train components 106 (see FIG. 1) within.

In FIG. 5, threaded bolts 120, spacers 122, and nuts 188 are shown fastening first plate 116 a specified distance from second plate 118. Each threaded bolt 120 is placed into a respective bolt hole in first or second plate 116, 118, passed through a spacer 122, passed through a respective bolt hole in the other of first or second plate 116, 118, and terminated with a nut 188.

In FIG. 5, one of the spacers 122 is extended through two OEM motorcycle mounts 123, 125 of motorcycle frame 102. One of the threaded bolts 120 is placed through bolt hole 138 in second plate 118, through the spacer 122 extending through mounts 123, 125, and through bolt hole 174 in first plate 116, being drawn tight by a nut 188.

It should be noted that while first plate 116 and second plate 118 are described and illustrated connected or fastened at a predetermined spacing according to a particular method using bolts and spacers, first plate 116 and second plate 118 can be fastened or connected according to other now-known or later-developed methods, using other now-known or later developed fasteners and/or spacers.

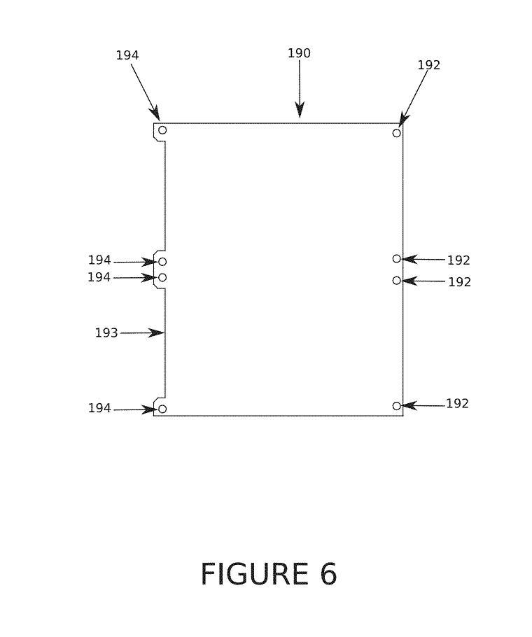

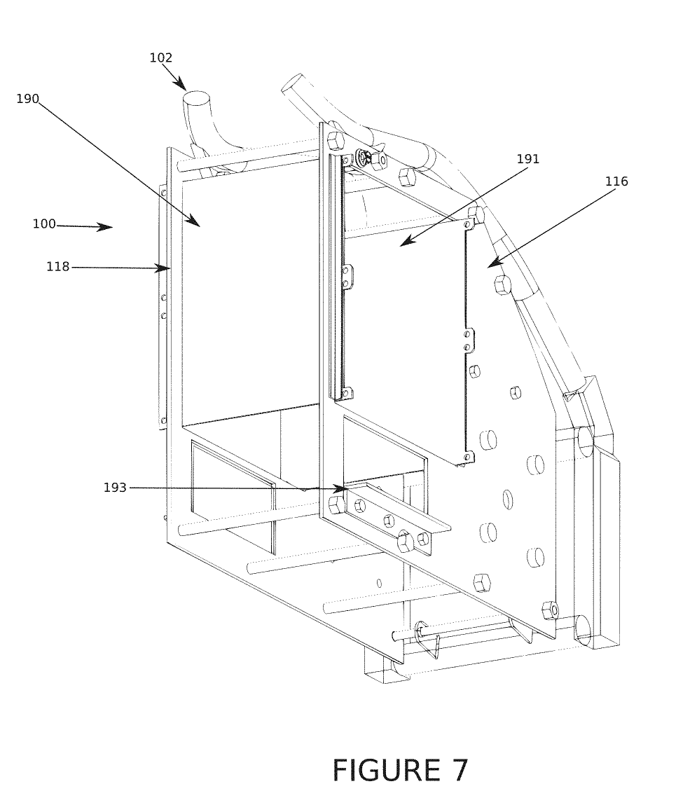

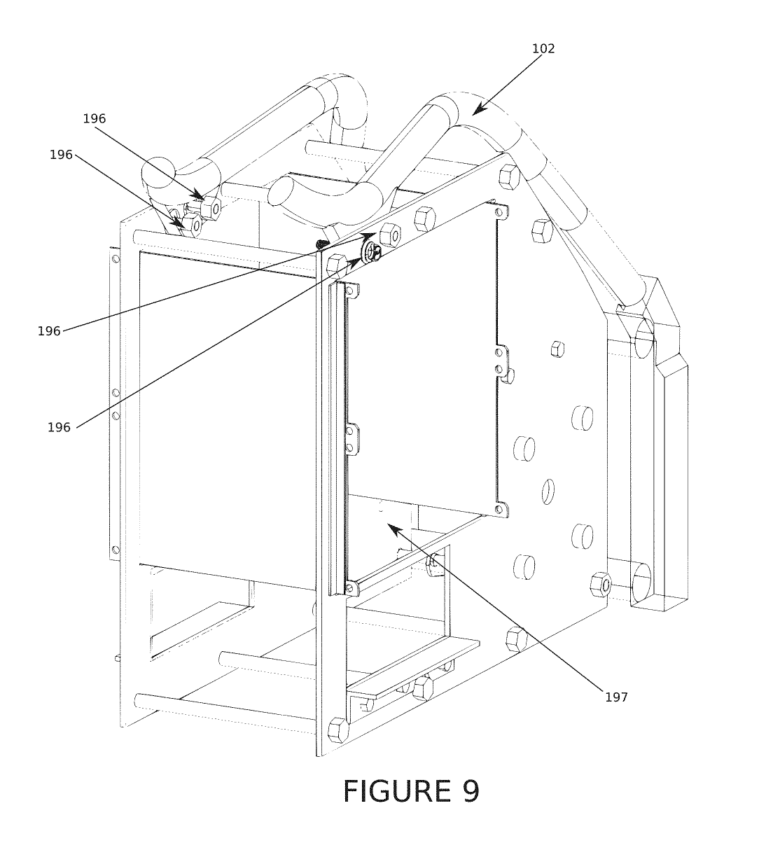

FIG. 6 illustrates a front view of a mounting plate 190 for battery pack 108 (see FIG. 1). FIG. 7 illustrates an isometric view of retrofit electric drive apparatus 100 mounted to partially shown frame 102 of a 2005 Kawasaki Ninja 250 (sans the fossil-fuel based drive train). Referring to FIG. 6 and FIG. 7, two identical mounting plates 190 can partly define a battery pack compartment 191 into which battery pack 108 can be positioned and mounted to facilitate mounting battery pack 108 (see FIG. 1) to housing 104. Battery pack compartment base 197 (see FIG. 9) can define a third side of battery pack compartment 191. The mounting plates 190 and battery pack compartment base 197 (see FIG. 9) can be coupled with first and second plates 116, 118 by now-known or later-developed fastening methods, or by simply fitting or positioning mounting plates 190 in place perpendicularly between connected first and second plates 116, 118, with battery pack 108 in battery pack compartment 191.

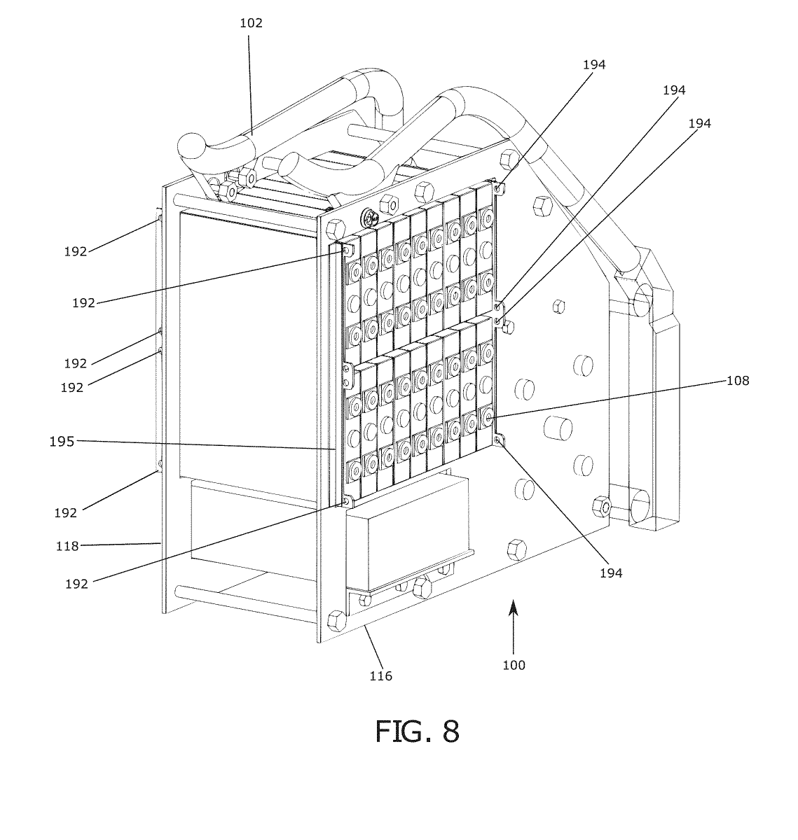

Mounting plate 190 can include mounting plate fastening holes 192, 194. Also represented are various holes for mounting battery pack 108 with threaded rods and nuts. Mounting plate fastening holes 192 mount the bottom of battery pack 108 to second plate 118 of retrofit electric drive apparatus 100, as will be seen in FIG. 8. Mounting plate fastening holes 194 mount the top of battery pack 108 to first plate 116 of retrofit electric drive apparatus 100, as will be seen in FIG. 8.

Referring to FIG. 7, a battery charger base support or battery charger mount, such as can be at least partially formed by battery charger angle bracket 193 can be mounted to first plate 116. An identical battery charger angle bracket (not shown) can be mounted to second plate 118. Angle brackets 193 can be mounted to first plate 116 and to second plate 118 using any conventional fastener. In FIG. 7, angle brackets 193 are shown bolted to first plate 116. Angle brackets 193 can provide a platform or surface upon which battery charger 112 can be supported.

FIG. 8 illustrates an isometric view of retrofit electric drive apparatus 100 mounted to partially shown frame 102 of a 2005 Kawasaki Ninja 250 (sans the fossil fuel based drive train). Shown in FIG. 8 are identical battery pack angle brackets 195 assembled on first plate 116 of retrofit electric drive apparatus 100 and forming part of a mounting structure for battery pack 108. Identical battery pack angle brackets 195 (not shown) are mounted on second plate 118. To secure battery pack 108 to retrofit electric drive apparatus 100, a threaded rod (not shown) can be passed into each hole 192, passed through battery back 108, and passed through each respective hole 194. Both ends of the threaded rod can be terminated with a nut. In other words, mounting plates 190 are inserted into first plate 116 and second plate 118 at a 90 degree angle with respect to first plate 116 and second plate 118, leaving an overhang on plates 190 on either side of the first plate 116 and second plate 118. 90 degree battery pack angle brackets are placed in the space between overhangs and mounted to the first and second plate 116, 118. Then the threaded rods and nuts go through the holes in the battery pack angle brackets, through one of the battery pack mounting plates 190, through battery pack 108, through the other of the battery pack mounting plates 190, and fastened on each end by nuts.

Angle bracket, threaded rod, and nut combination as described with respect to first plate 116 can also identically secure battery pack 108 to second plate 118.

FIG. 9 illustrates an isometric view of retrofit electric drive apparatus 100 mounted to partially shown frame 102 of a 2005 Kawasaki Ninja 250 (sans the fossil fuel based drive train). Referring to FIG. 9, retrofit electric drive apparatus 100 is mounted to partially shown OEM motorcycle frame 102 at mount points 196 of OEM motorcycle frame 102. At each mount point 196, an apparatus mounting connector 199 can fasten to the frame 102 and to the housing 104. The connectors 199 can be any suitable now-known or later-developed connector. In the embodiment illustrated in FIG. 9, the connector 199 is bolted to the housing 104 at mount points 196. The mount points 196 can vary depending on the particular make and model of motorcycle, and bolt holes 128, 130, 164, 166 (see FIG. 2 and FIG. 3) can be relocated accordingly.

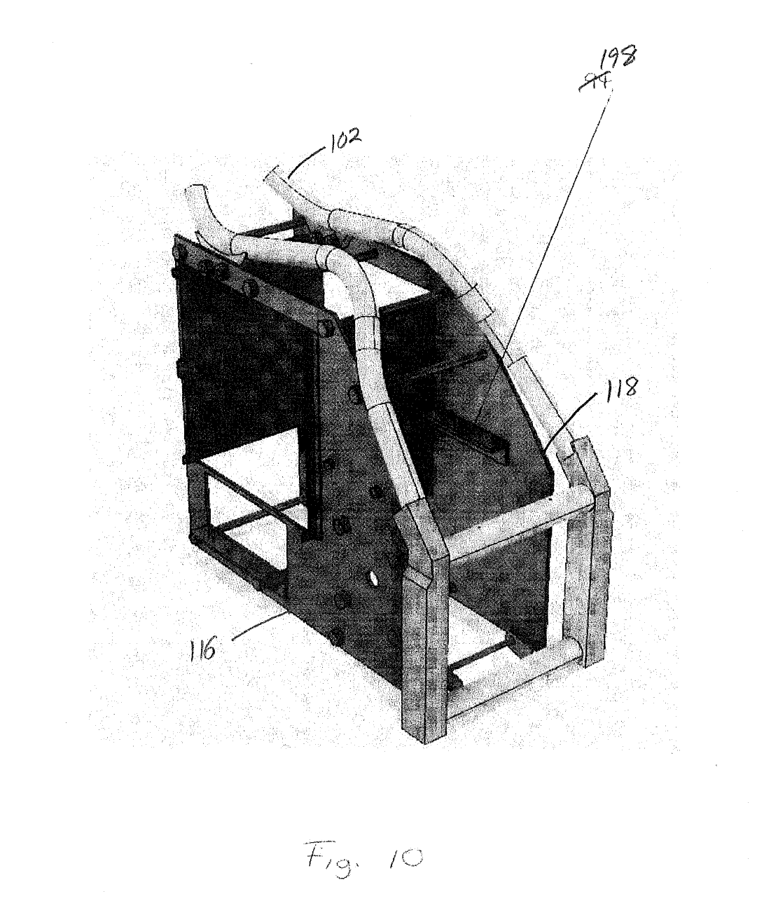

FIG. 10 illustrates an isometric drawing view of retrofit electric drive apparatus 100 mounted to partially shown frame 102 of a 2005 Kawasaki Ninja 250 (sans the fossil-fuel based drive train). In FIG. 10, a motor controller support, such as angle bracket 198, is attached to second plate 118 for mounting an electric drive train component 106 such as motor controller 110 (see FIG. 1). An identical angle bracket (not shown) is attached to first plate 116 at the same relative position on the first plate 116.

It should be noted that while illustrated and described in a particular fashion with respect to the figures, each electric drive train component 106 can be mounted or secured to first plate 116 and/or second plate 118 by any now-known or future-developed fastening method.

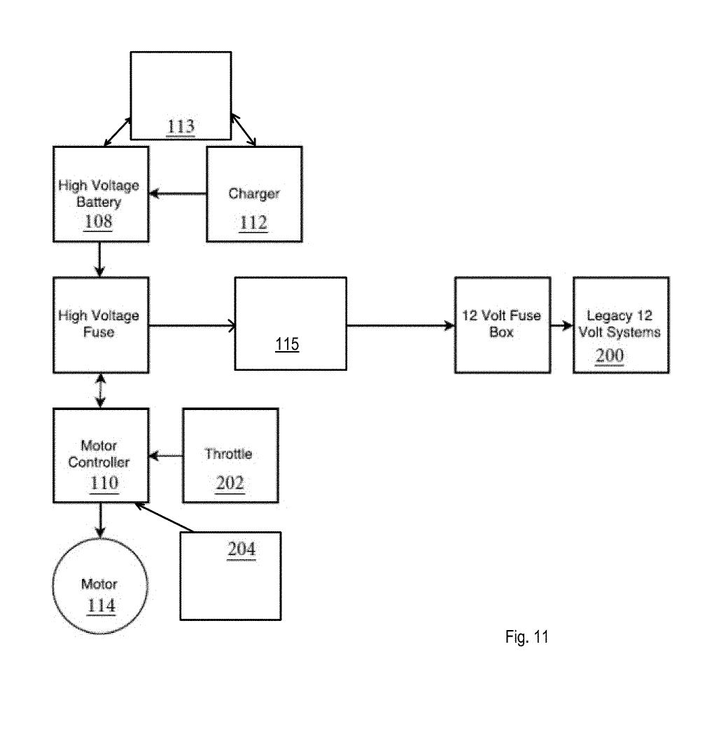

FIG. 11 is a block diagram of the operational relationship of drive train components of the retrofit electric drive apparatus 100, according to one embodiment. Referring to FIG. 11, in operation, battery pack 108 stores energy to power the drivetrain systems including electric motor 114 and existing 12-volt systems 200 of the motorcycle, such as turn indicator lights, brake lights, etc. 12-volt voltage regulator 115 takes high voltage from battery pack 108 and drops it down to a voltage level needed to run the motorcycle's low voltage systems such as headlights, turn signals, etc. 12-volt voltage regulator 115 can be electrically coupled to the motorcycle's pre-existing starter.

Battery pack 108 is electrically coupled to battery charger 112 such that battery charger 112 charges battery pack 108 as a result of being connected to AC power by charging connector (shown in photos). Battery charger 112 also can be electrically coupled to battery management system 113. Battery management system 113 can control battery charger 112 and can regulate each cell of battery pack 108 to remain at a homogeneous voltage. If battery charger 108 malfunctions and keeps charging battery pack 108 when each cell is full, then battery management system 113 disables battery charger 112.

Motor controller 110 can be electrically coupled to the pre-existing electronic throttle 202 of the motorcycle and to the pre-existing key switch 204. Activation of the key switch 204 can initiate a signal to the motor controller 110 to start electric motor 114. In the 2005 Kawasaki Ninja 250, the pre-existing electronic throttle uses a potentiometer on a sprint return to feed a 0-5K resistance value to motor controller 110. Motor controller 110, which is also electrically coupled to electric motor 114, uses this data to generate a pulse width modulation signal to drive electric motor 114 at variable speeds.

Electric motor 114 propels the motorcycle by spinning drive shaft 159, which is connected to a sprocket, which links to a chain, which is further linked to a rear sprocket on the rear wheel of the motorcycle.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A retrofit electric drive apparatus for converting a fossil fuel fitted motorcycle into an electric-powered motorcycle, the apparatus comprising:
a housing including a motorcycle frame mounting element for fastening to a motorcycle frame, the housing shaped to reside within an envelope defined by the motorcycle frame, at least a portion of the housing shaped to congruously match a portion of the motorcycle frame;
a battery pack mounted to the housing;
a battery charger electrically coupled to the battery pack to electrically charge the battery pack from an AC power source;
an electric motor operatively coupled to the battery pack by an electric motor controller and controlled by a battery management system, the electric motor mounted to the housing and coupled to a drive shaft, the drive shaft configured to connect to a sprocket and chain drive mechanism of the motorcycle.

2. The retrofit electric drive apparatus as recited in claim 1, wherein the battery pack, the battery charger, the electric motor, and the electric motor controller are each positioned at least mostly within an internal space defined by the housing.

3. The retrofit electric drive apparatus as recited in claim 1, wherein the housing comprises a first battery pack mounting plate, a second battery pack mounting plate, and a third battery pack mounting plate, the first battery pack mounting plate parallel with the second battery pack mounting plate, the third battery pack mounting plate perpendicular to and connecting between the first battery pack mounting plate and the second battery pack mounting plate, the first, second, and third battery pack mounting plates defining a battery pack compartment to hold the battery pack.

4. The retrofit electric drive apparatus as recited in claim 1, wherein the housing comprises a battery charger base support to support the battery charger.

5. The retrofit electric drive apparatus as recited in claim 4, wherein the battery charger base support includes an angle element attached on an external face of the housing.

6. A retrofit electric drive apparatus for converting a fossil fuel fitted motorcycle into an electric-powered motorcycle, the apparatus comprising:
a housing kit including:
a first plate element;
a second plate element;
at least one spacer configurable to space the first plate from the second plate; and
a motorcycle frame mounting element for fastening the first plate and the second plate to a motorcycle frame,
the first plate element fastenable to the second plate element at a spacing determined by the at least one spacer, the first plate element and the second plate element each shaped to reside within an envelope defined by the motorcycle frame.

7. The retrofit electric drive apparatus as recited in claim 6, wherein at least a portion of the first plate element and the second plate element has a perimeter shaped congruously with a portion of the motorcycle frame.

8. The retrofit electric drive apparatus as recited in claim 6, wherein the first plate element and the second plate element each include a battery opening sized to fit a battery pack, a battery charger opening sized to fit a battery charger, and a drive shaft opening sized to fit a motorcycle drive shaft.

9. The retrofit electric drive apparatus as recited in claim 6, wherein the first plate element and the second plate element are each shaped in the form of a rectangle with a chamfered corner.

10. The retrofit electric drive apparatus as recited in claim 6, wherein the housing after assembly is no wider than the frame of a motorcycle beneath a seat of the motorcycle.

11. The retrofit electric drive apparatus as recited in claim 6, wherein the housing kit further includes a battery charger base support attachable to at least one of the first plate element and the second plate element.

12. The retrofit electric drive apparatus as recited in claim 6, wherein the housing kit further includes a motor controller support attachable to at least one of the first plate element and the second plate element.

13. A retrofit electric drive apparatus for converting a fossil fuel fitted motorcycle into an electric-powered motorcycle, the apparatus comprising:
a housing including a first side element and a second side element, the first side element connected to the second side element at a predetermined spacing to create an internal space between the first side element and the second side element,
the housing shaped to reside within an envelope defined by the motorcycle frame, at least a portion of the housing shaped to be congruous with the motorcycle frame defining the envelope, the envelope being under a seat of the motorcycle and between a front wheel and a rear wheel of the motorcycle.

14. The retrofit electric drive apparatus as recited in claim 13, further comprising at least one motorcycle frame mounting element for fastening the housing to a motorcycle frame.

15. The retrofit electric drive apparatus as recited in claim 13, wherein the housing includes at least two from the group consisting of a battery opening sized to fit a battery pack, a battery charger opening sized to fit a battery charger, and a drive shaft opening sized to fit a motorcycle drive shaft.

16. The retrofit electric drive apparatus as recited in claim 13, wherein the housing has a cross-sectional shape in the form of a rectangle with a chamfered corner.

17. The retrofit electric drive apparatus as recited in claim 13, wherein the internal space can fit an electric motor operable to drive a motorcycle, a battery pack operable to power the electric motor, an electric motor controller, and a battery charger operable to charge the battery pack.

18. The retrofit electric drive apparatus as recited in claim 13, wherein the housing further includes a plurality of spacers extending between and connecting the first side element and the second side element.

19. The retrofit electric drive apparatus as recited in claim 13, wherein the first side element and the second side are parallel.

20. The retrofit electric drive apparatus as recited in claim 13, wherein the housing further includes a battery compartment, a battery charger compartment, and internal space for an electric motor and an electric motor controller.
